(19) United States
(12) Patent Application Publication
(10) Pub. No.: US 2007/0222162 A1
(43) Pub. Date: Sep. 27, 2007

(54) Back-up ring and sealing assembly

(76) Inventor: Jack Chapman Stoner, Harris County, TX (US)

Correspondence Address: C. JAMES BUSHMAN, 5718 WESTHEIMER, SUITE 1800, HOUSTON, TX, 77057, US

(21) Appl. No.: 11/388,383

(22) Filed: Mar. 24, 2006

(51) Int. Cl. F16J 15/00

(52) U.S. Cl. 277/589

(57) ABSTRACT

A back-up ring for use in a sealing assembly having an annular body with a first face and a second face and defining an axial thickness, the first face being adapted to be engaged by an annular seal ring, a first cut in the first face extending axially inwardly from the first face at an angle of less than 90° but greater than 0° to the first face, a second cut in the second face, the second cut being interconnected to the first cut and being at an angle thereto, the angle of at least a portion of the second cut being 90° or greater but less than 180° to the second face.

### BACKGROUND OF THE INVENTION

1. Field of the Invention

The present invention relates to sealing assemblies for sealing between radially inner and radially outer members and, more particularly, to a back-up or anti-extrusion ring for use in such assemblies.

2. Description of Prior Art

Annular seal rings, e.g., O-rings, are frequently utilized to provide a fluid seal between two, radially inner and outer members, e.g., a shaft and a stuffing box, two tubular members, etc. The members can be relatively movable, e.g., rotatable, reciprocating, oscillatory or stationary.

Seal rings generally used are often made of a flexible and/or resilient material, such as natural rubber, synthetic rubber, ethylene-propylene rubbers, PTFE, etc. Seal rings made of these materials provide satisfactory sealing at comparatively low pressures and temperatures. However, at higher pressures and temperatures the seal rings do not always work satisfactorily. High temperature may soften the material of the seal ring making it subject to extrusion.

To prevent extrusion of the seal ring, it is common to use a back-up ring downstream of the seal ring vis-à-vis the pressure acting on the seal ring. These back-up rings are harder than the seal rings, are split and have tightly held tolerances to minimize any gaps into which the seal ring could extrude under pressure. For example, softening of the seal ring under high temperatures can extrude the seal ring into the gap resulting in damage to the seal ring. When the high pressure and temperature conditions end, any extruded portion of the seal ring may not withdraw from the previously enlarged gap in the back-up ring. In that event the seal ring may be damaged and when the high pressure and high temperature condition is next experienced, the damaged seal ring may not provide an adequate seal. This problem is exacerbated with each cycle of high pressure and/or high temperature.

Radial seals form a pressure barrier between the internal diameter of an outer member, e.g., the bore of a gland, and the outer diameter of an internal member, e.g., a shaft or tube. Radial seal glands require the seal ring and back-up ring be stretched or compressed diametrically for installation into so called closed glands. Since hard back-up rings do not have the elasticity to deform into the closed gland as a solid ring, they must be split so that they can be expanded or compressed into the gland.

Ideally the split, C-shaped back-up ring has the exact length of the circumference of its intended gland or outer member. In some cases, the split in the back-up ring is made radially so as to pass through the ring axis. Back-up rings cut in this fashion have an easy extrusion path through the radial gap for a seal ring. To overcome this problem, the split in the back-up ring typically is made such that the adjoining portions of the back-up ring overlap, e.g., a scarf cut. Thus, in the case of a scarf cut ring, when the ring is subjected to sufficiently high temperatures, the faces of the scarf cut can slide relative to one another to accommodate the dimensional change.

Temperature demands for application of elastomeric seals and their back-up rings are constantly increasing. Heating a split back-up ring increases its total circumference. However, this can create a poor (non-planar) support surface for the seal ring, and when pressurized can damage the seal and impair its sealing ability.

### SUMMARY OF THE INVENTION

The present invention, in one aspect, provides a back-up ring for use in a sealing assembly, the back-up ring comprising an annular, split body having a first face, adapted to be engaged by a seal ring and an axially spaced second face. The first and second faces define an axial thickness of the back-up ring. There is a first cut in the first face, the first cut extending to a point intermediate the first and second faces, the first cut being at an angle of less than 90° but greater than 0° to the first face. There is a second cut in the second face, the first and second cuts being interconnected. The first cut is at an angle to the second cut, the angle of at least a portion of the second cut being 90° or greater but less than 180° to the second face. The second cut preferably has a width allowing circumferential expansion of the body and reduction of the width of the second cut.

In another aspect the present invention provides a sealing assembly comprising a back-up ring as described above and an annular seal ring in engagement with the first face of the back-up ring.

### BRIEF DESCRIPTION OF THE DRAWINGS

FIG. 1 shows a typical pressure housing containing a back-up ring and an O-ring seal to effect sealing between the housing and the piston upon which the back-up ring and seal ring are mounted.

FIG. 2A is an elevational view, partly in section, showing a prior art sealing assembly wherein the back-up ring has a radial split at 90° to the face of the back-up ring.

FIG. 2B is an end view of the sealing assembly shown in FIG. 2A.

FIG. 3 is a view similar to FIG. 2A showing pressure applied to the sealing assembly of FIG. 2A and a portion of the seal ring extruded into the gap of the back-up ring.

FIG. 4 is an elevational view, partly in section, of another prior art sealing assembly wherein the radial cut through the back-up ring is at an angle of less than 90° to the face of back-up ring.

FIG. 5 is a view similar to FIG. 4 showing the sealing assembly of FIG. 4 with pressure applied to the seal ring.

FIG. 6 shows the sealing assembly of FIG. 4 in a high temperature condition wherein the circumference of the back-up ring has increased causing the opposed faces of the back-up ring to be non-planar.

FIG. 7 is an elevational view of one embodiment of the back-up ring and sealing assembly of the present invention.

FIG. 8 is a view similar to FIG. 7 showing the effect of pressure acting upon the sealing assembly of FIG. 7 closing the cut in the face of the back-up ring adjacent the seal ring.

FIG. 9 shows the sealing assembly of FIG. 7 under high temperature conditions wherein the circumference of the back-up ring has expanded and the cut on the face of the back-up ring distal the seal ring has closed.

FIG. 10 is an elevational view showing another embodiment of the back-up ring and sealing assembly of the present invention.

FIG. 11 is an elevational view, partly in section, showing another embodiment of the sealing assembly of the present invention.

FIG. 12 is an elevational view, partly in section, showing another embodiment of the sealing assembly of the present invention.

FIG. 13 is an elevational view, partly in section, showing another embodiment of the back-up ring for use in the sealing assembly of the present invention.

FIG. 14 is an elevational view, partly in section, showing another embodiment of the back-up ring used in the sealing assembly of the present invention.

FIG. 15 is an end, plan view of the back-up ring of the present invention showing the cut in the face of the back-up ring being a radial cut through the diameter of the back-up ring; and

FIG. 16 is a view similar to FIG. 15 but showing the radial cut in the face of the back-up ring passing through a non-diametric chord of the back-up ring.

FIG. 17 is a fragmentary, enlarged view of a portion of FIG. 3.

FIG. 18 is an elevational view, partly in section, showing another embodiment of the back-up ring used in the sealing assembly of the present invention.

FIG. 19 is an elevational view, partly in section, showing another embodiment of the back-up ring used in the sealing assembly of the present invention.

### DETAILED DESCRIPTION OF PREFERRED EMBODIMENTS

While the present invention will be described below with respect to sealing between relatively movable members, it is to be understood that it is not so limited and that the sealing assembly and back-up ring of the present invention can be used to seal between any type of radially inner and radially outer members regardless of whether such members are relatively movable, e.g., reciprocable, rotatable, oscillatory, or stationary.

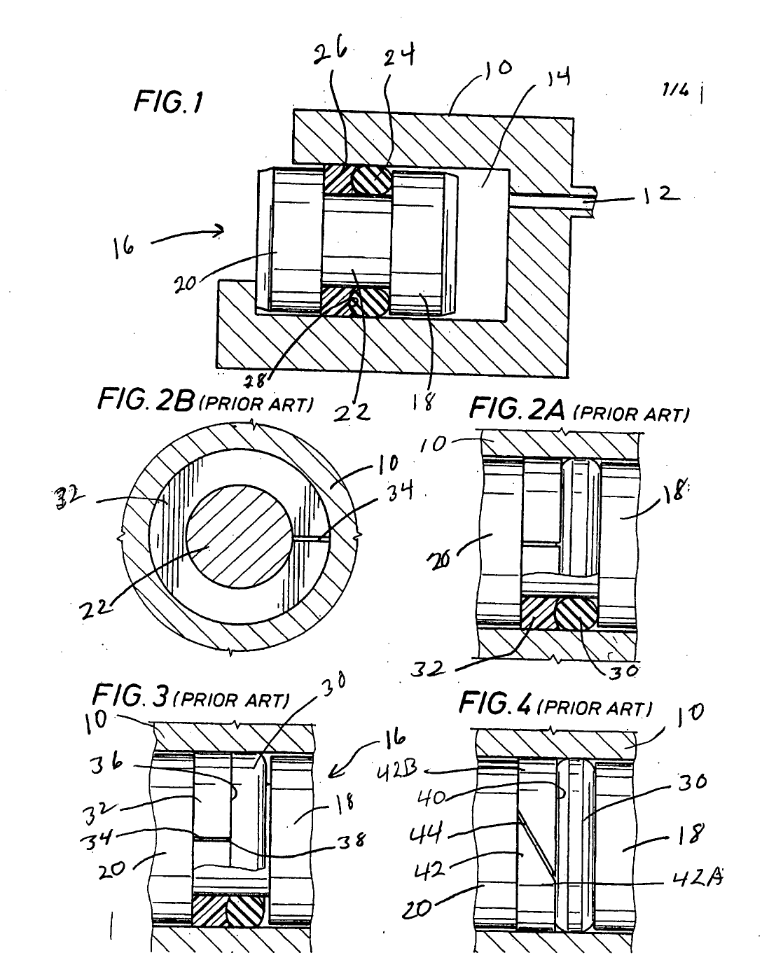

Turning first to FIG. 1, there is shown a typical arrangement wherein the back-up ring and sealing assembly of the present invention could be employed. Referring then to FIG. 1, there is a pressure housing 10 having a pressure inlet port 12 which communicates with an internal chamber 14 of the housing 10. Disposed in chamber 14 is a piston shown generally as 16 having a first head 18 and a second head 20 connected by piston rod 22. Disposed between heads 18 and 20 and in surrounding relationship to piston rod 22, is an O-ring seal 24 and a split back-up ring 26. As can be seen, back-up ring 26 has an annularly extending axially facing concave recess 28 in which O-ring seal 24 is nested. As is well known, back-up ring 26 serves the purpose of preventing seal ring 24, which is of a resilient and generally much softer material than back-up ring 26, from extruding when pressure is applied in chamber 14 through pressure conduit 12. Thus, the sealing assembly comprised of seal ring 24 and back-up ring 26 serves to form a seal between reciprocating piston 16 and housing 10.

Turning to FIG. 2A, there is shown a typical prior art sealing assembly. Thus, the sealing assembly comprises an O-ring seal 30 and a back-up ring 32, the configuration shown in FIG. 2A being substantially as shown in FIG. 1. The sealing assembly of 2A is in the relaxed condition, i.e., without any pressure acting upon head 18 of the piston 16. As can be seen in FIG. 2B, back-up ring 32 has a radial cut 34 giving back-up ring 32 a generally C-configuration.

Referring now to FIG. 3, the sealing assembly of FIGS. 2A and 2B is shown with pressure acting upon piston head 18. As can be seen, with the sealing assembly under pressure, seal ring 30 is flattened against the first face 36 of back-up ring 32. Additionally, a small portion 38 of seal ring 30 has extruded into gap 34 (see FIG. 17). It will be appreciated that if the pressure condition is riow released such that seal ring 30 essentially resumes the configuration shown in FIG. 2A, the portion 38 extruded into groove 34 may well remain extruded. Accordingly, when pressure conditions are again experienced on piston head 18, seal ring 30 may prove to be an ineffective seal between housing 10 and piston 16.

Turning now to FIG. 4, there is shown another prior art sealing assembly. In the embodiment shown in FIG. 4, the sealing assembly is not under pressure as can be seen from the relaxed condition of seal ring 30. Seal ring 30 is in engagement with a first surface 40 of a back-up ring 42 having a radial, angled or scarf cut 44 forming a lap joint between the two ends 42A and 42B of back-up ring 42.

Turning now to FIG. 5, the sealing assembly of FIG. 4 is shown with pressure acting on piston head 18. As can be seen, seal ring 30 has been flattened against the face 40 of back-up ring 42. Additionally, as can be seen, the lap joint created by scarf cut 44 has closed.

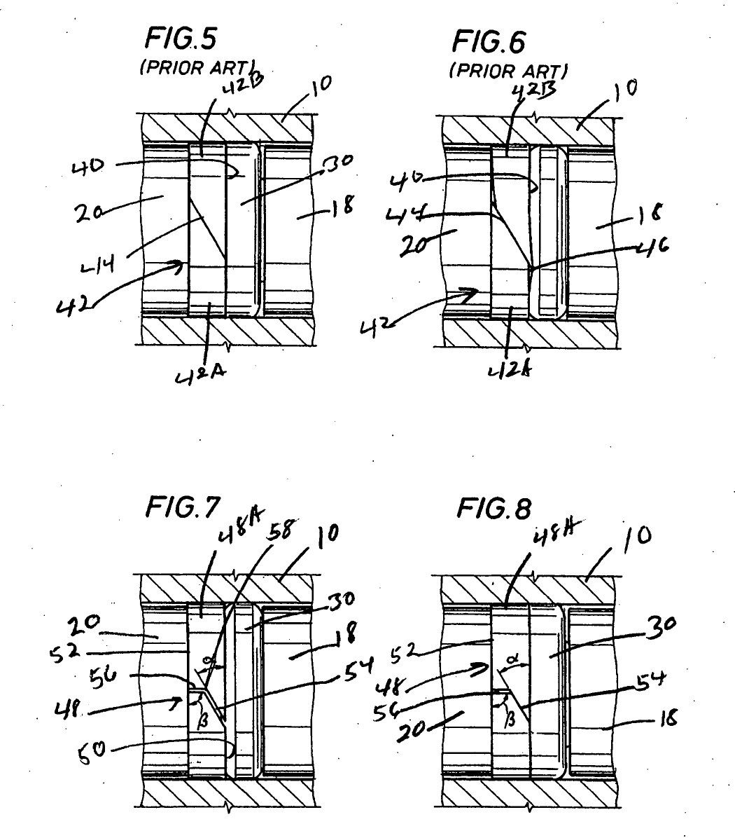

FIG. 6 depicts the sealing assembly of FIG. 4 wherein the sealing assembly is subjected to high temperatures. As can be seen, under the influence of high temperature, seal ring 42 has expanded in circumference. The circumferential expansion causes the portions 42A and 42B on either side of the lap joint created by scarf cut 44 to shift relative to one another with the result that face 40 of back-up ring 42 rather than being planar now has a portion 46 of the back-up ring 42 projecting axially out of the face 40 of back-up ring 42 and into the relatively soft material of the seal ring 30. This clearly can cause damage to the seal ring 30 since it may cause a cut in the portion of the seal ring 30 engaged with the face 40 of back-up ring 42. Accordingly, even though the temperature is decreased, if high temperature is again encountered, seal ring 30 may not form an effective seal.

As can be seen from the above description of prior art back-up rings, temperature and/or pressure acting on the back-up ring can have serious effects on the integrity of the seal ring. Thus, as shown in FIG. 3, pressure acting upon a sealing assembly employing a back-up ring with a 90 degree radial cut therethrough can result in the relatively soft material of the seal ring extruding into the gap created by the radial cut. In the case of a sealing assembly using a back-up ring with a radial, scarf cut to create a lap joint, pressure will close the lap joint created by the scarf cut but temperature, as shown in FIG. 6, can cause the faces of the back-up ring forming the lap joint to shift relative to one another possibly resulting in damage to the resilient seal ring and preventing the seal ring from forming an effective seal in subsequent cycles of heating and cooling.

Turning now to FIG. 7, there is shown one embodiment of the sealing assembly of the present invention. As shown in FIG. 7, the sealing assembly comprises resilient O-ring seal 30 and a split back-up ring 48. Split back-up ring 48 has a body 48A, first surface 50 which is engaged by seal ring 30 and a second surface 52 axially displaced from surface 50, surfaces 50 and 52 defining an axial thickness of back-up ring 48 through body 48A. Formed in the face 50 of back-up ring 48, is a radial, angled or scarf cut 54 which terminates at a point intermediate faces 50 and 52, cut 54 being at an angle a of between 90° and 0° as determined by using a polar coordinate system in a plane with the center of the system being at the intersection of cut 54 and face 50. Scarf cut 54 is intersected by a 90 degree radial cut 56 at a point 58 which, as shown, is approximately midway between faces 50 and 52. Like cut 54, the angle β of cut 56 is also measured using a polar coordinate system in a plane, the center of the system being at the intersection of cut 56 and face 52. In the condition shown in FIG. 7, the sealing assembly comprised of seal ring 30 and back-up ring 48 is at an ambient condition, i.e., with no pressure acting upon piston head 18 and the sealing assembly being generally at ambient temperature or at least not at any temperature high enough to cause any significant circumferential expansion of back-up ring 48.

Turning to FIG. 8, the sealing assembly of FIG. 7 is shown under conditions wherein pressure is acting upon piston head 18 and hence on seal ring 30. In this condition, seal ring 30 is compressed against seal face 50 with the result that the lap joint created by scarf cut 54 closes thereby preventing any extrusion of seal member 30 into the lap joint created by scarf cut 54. In the case shown in FIG. 8 and when the sealing assembly is only under pressure, radial cut 56 remains substantially unaffected vis-à-vis its width. In any event, it can be seen that seal ring 30 is substantially prevented from any extrusion by back-up ring 48.

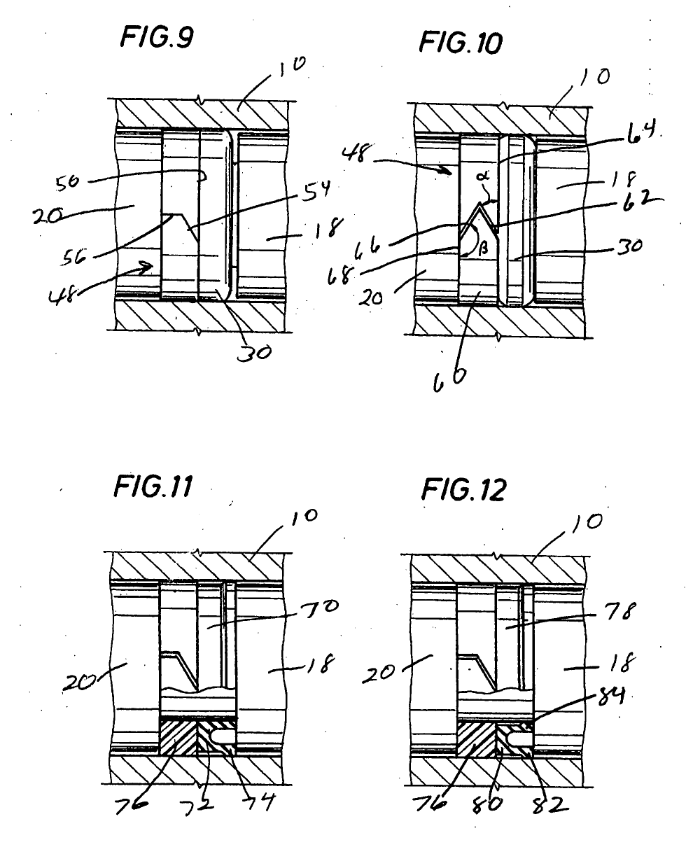

Turning to FIG. 9, the sealing assembly of FIG. 7 is shown under high temperature conditions. Under these conditions, radial cut 56 on the second face of back-up ring 48 will be caused to shrink and perhaps even close depending upon temperature conditions; however, the faces making up the lap joint caused by scarf cut 54 are precluded from any relative axial sliding action, albeit that scarf cut 54 may close under high temperature conditions, thereby preventing the first face 50 of back-up ring 48 from assuming a non-planar configuration which, as noted above with respect to prior art scarf cut back-up rings can result in a portion of the back-up ring protruding into the seal ring 30 (see FIG. 6).

Turning now to FIG. 10, there is shown another embodiment of the present invention wherein back-up ring 60 has a first scarf cut 62 extending from the face 64 which is engaged by the seal ring 30 and a second scarf cut 66 extending from face 68, cuts 62 and 66 intersecting at a point intermediate faces 64 and 68. Using the coordinate system as described above to determine the angle of angles α and β, it can be seen that angle α is less than 90° to face 64 while angle β is at an angle of greater than 90° to face 68.

FIG. 11 shows another embodiment of the present invention wherein rather than an O-ring type seal ring, the seal ring 70 is of the lip seal type having a body portion 72 and a radially outward projecting lip 74, lip 74 being in sealing engagement with housing 10. Back-up ring 76 can be of any type according to the present invention, e.g., of the type shown in FIG. 7 or 10 or any other version of the present invention as described hereinbefore and hereafter.

Referring now to FIG. 12 there is shown another embodiment of the present invention where the seal ring 78 is generally of the cup type having a body portion 80, an annularly extending, radially outwardly projecting lip 82 and an annularly extending, radially inwardly projecting lip 84, lip 82 being in sealing engagement with housing 10, lip 84 being in sealing engagement with piston rod 22 connecting piston heads 18 and 20. Back-up ring 76 can be as described above with respect to the embodiment shown in FIG. 11.

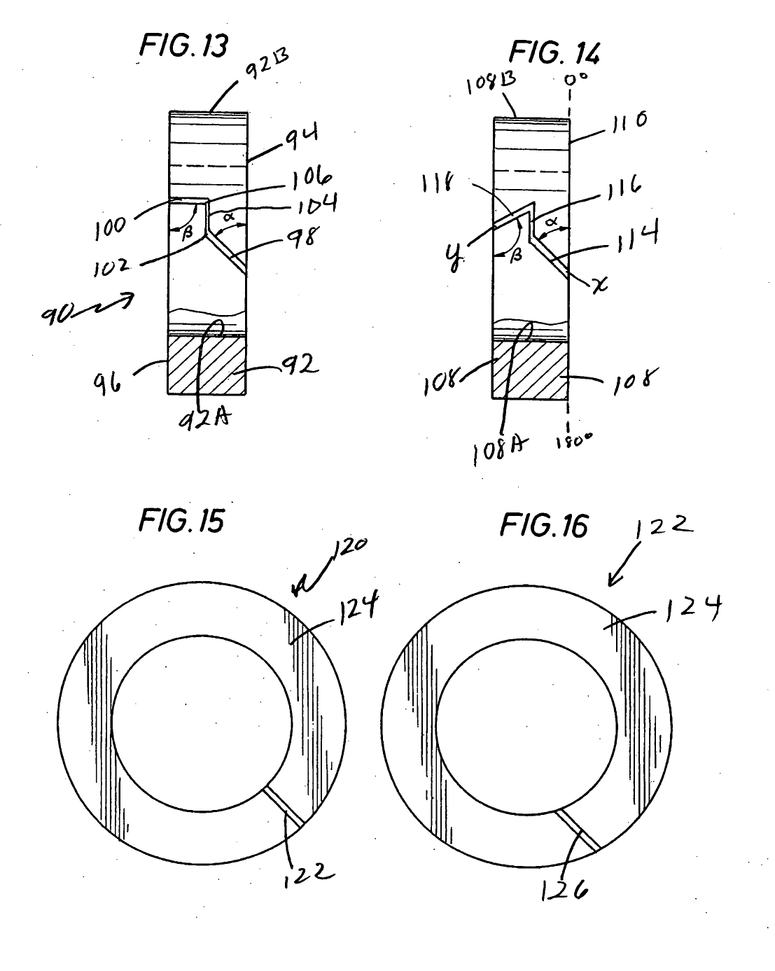

Referring now to FIG. 13, there is shown another embodiment of the present invention. In the prior embodiments of the present invention, the back-up ring is comprised two cuts, one cut extending from a first face of the back-up ring, a second cut extending from a second, axially spaced face of the back-up ring, the two cuts intersecting at a point intermediate the first and second faces. FIG. 13 depicts an embodiment of the present invention wherein the back-up ring, shown generally as 90, has an annular body portion 92 having a first face 94 adapted to engage a seal ring, a second, axially spaced face 96, an inner, annularly extending surface 92A and an outer annularly extending surface 92B. First face 94 has a radial, scarf cut 98 forming a lap joint. Second face 96 has a 90 degree, radial cut 100. Cut 98 intersects one end 102 of a cut 104 which extends intermediate faces 94 and 96 and generally parallel thereto. The other end of cut 104 is intersected as at 106 by radial cut 100. Cut 104 extends from outer, annular surface 92B to inner, annular surface 92A. While cut 104, as shown and described is generally parallel to faces 94 and 96, it will be understood that it could be at some angle to those surfaces provided cut 104 intersected radial scarf cut 98 and 90 degree radial cut 100, preferably at the respective ends of the three cuts. As seen, the scarf cut 98 is at an angle a of less than 90° to face 94. Cut 100 on the other hand is at an angle β of 90° to the face 96 of back-up ring 90.

Referring now to FIG. 14, there is shown another embodiment of the present invention similar to that shown in FIG. 13. Thus, the back-up ring is comprised of an annular body 108 having a first face 110 adapted to engage a seal ring and a second face 112 axially spaced from face 110. A scarf cut 114, at an angle a of less than 90° to face 110, extends from first face 110 to a point intermediate faces 110 and 112. Scarf cut 114 intersects a cut 116 located between faces 110 and 112 and generally parallel thereto although, as noted above with respect to cut 104, cut 116 could be at some angle to faces 110 and 112, provided it was interconnected to cuts 114 and 118. Like cut 104 in FIG. 13, cut 116 extends between and through an annular, outer surface 108B and an inner, annular surface 108A of body 108. Cut 118, is at an angle β which is greater than 90° to face 112, the angle of cut 114 being substantially the same as the angle of cut 98.

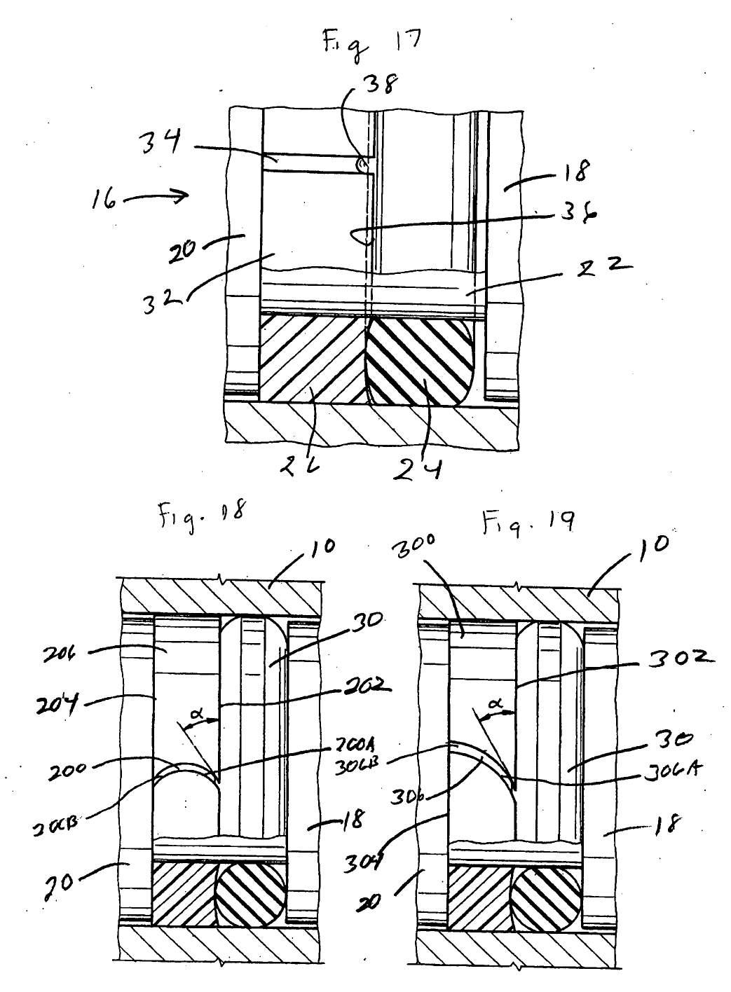

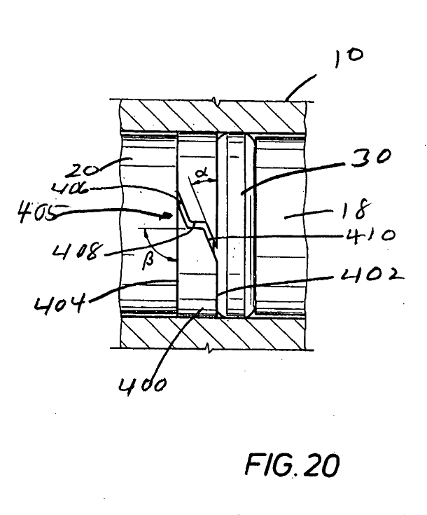

FIG. 15 shows a back-up ring wherein the first and second cuts, at their respective faces, extend through the center of the ring. Thus, as shown in FIG. 15, back-up ring 120 has a cut 122, the commencement of which on face 124 passes through the center of the back-up ring 120. FIG. 16 shows a variation wherein the back-up ring 122 having a face 124 has the cut 126, as measured on the face 124, is off center in the sense that the cut does not pass through the center of the back-up ring 122. Rather, cut 126 subtends a chord passing through back-up ring 122 which is less than the diameter of the back-up ring 122.

Referring now to FIG. 18, there is shown another embodiment of the present invention wherein back-up ring 206 has two cuts comprised of a single arc cut 200 which extends from a first face 202 to a second face 204 of back-up ring 206. Thus, the embodiment shown in FIG. 18 is essentially a variation of that shown in FIG. 10 and demonstrates that the cuts not be straight but can be curved. Thus, arc cut 200 is comprised of first run or portion 200A which extends from first face 202 and second run or portion 200B which extends from second face 204. In determining the angles of the cuts determined by runs 200A and 200B, a line tangential to the cuts such as shown for example in determining angle α can be employed, the same coordinate system described above being used.

FIG. 19 again shows the use of cuts which are not straight but which still fall within the scope of the present invention. In essence, the embodiment shown in FIG. 19 is substantially the same as that shown in FIG. 7 with the exception that unlike FIG. 7 where the cuts are straight, in FIG. 19 the cuts are curved. Thus, back-up ring 300 has a first face 302 and a second face 304, there being an arch-shaped cut 306 which extends from face 302 to face 304. As in the case of the embodiment shown in FIG. 18, cut 306 has a first run 306A which extends from first face 302 and a second run 306B which extends from second face 304, the runs 306A and 306B intersecting, as in the case of the cuts shown in FIG. 7 and a point intermediate between faces 302 and 304. Once again the angle a can be determined by a tangential line as shown in FIG. 19. Additionally, although not shown, the angles β between the face 204 and run 200B of cut 200 in FIG. 18 and between run 306B and face 304 in FIG. 19 can also be determined by tangential lines.

As noted above, in measuring the angles of the various cuts described above, a polar coordinate system in a plane is employed, the center of the system being at the intersection of the cut and the face into which it is cut. Thus with respect to FIG. 14 and by way of example only in determining the angle of cut 114, with the center of the coordinate system being at X in FIG. 14, 0° and 180° in the coordinate system would be on an imaginary line passing through surface 110 as shown. With this coordinate system, 90°, as shown, would then be on an imaginary line perpendicular to the line on which 0° and 180° lie, i.e., perpendicular to face 110. The angle of the cut on the second face, e.g., β in FIG. 14 would be measured in a similar manner with the exception that now the center of the coordinate system would be at Y.

Using the above described coordinate system, the cut in the face which is engaged by the seal ring (first face) will be at an angle a to that face which is less than 90° but greater than 0°, preferably at an angle of from 20 to 70°, most preferably at an angle of about 25 to 35°. The second cut, i.e., the cut on the face distal the seal ring will be 90° or greater but less than 180° preferably at an angle of from 90 to 160°, most preferably at an angle of 90°. This relative angling of the cuts minimizes any overlap that might occur if the back-up ring is subjected to high temperatures. For example, with reference to FIGS. 13 and 14, it can be seen that the cuts 100 and 118 effectively prevent any shifting of the opposed faces making up the lap joints created by cut 98 (FIG. 13) or cut 114 (FIG. 14). Indeed, in the case of the embodiment shown in FIG. 14, cut 118 forms a partial dovetail when viewed in side elevation, the dovetail serving to virtually preclude any sliding movement of the faces of the lap joint formed by cut 114, thereby preventing any overlap rendering face 110 non-planar.

Turning now to FIG. 20, there is shown another embodiment of the present invention wherein the back-up ring 400 is symmetric, i.e., either the first face 402 or the second face 404 could be engaged by the seal ring 30. Although not absolutely necessary, in the embodiments described above and wherein an O-ring is the seal ring, it is common for the face of the back-up ring which is engaged by the O-ring to have a shallow, annular recess in which the O-ring can nest. In cases where there is no nesting of the O-ring or other type seal ring in the back-up ring, a symmetrical back-up ring such as back-up ring 400 shown in FIG. 20 can be employed. In addition to depicting a symmetrical back-up ring, FIG. 20 also shows that the second cut shown generally as 405 can have two runs or portions. Thus, second cut 405 has a first run or portion 406 which is cut into face 404 and a second run or portion 408 which, as shown by the angle β is 90° to face 404. First cut 410 is at an angle a to face 402 which is less than 90° as determined in the manner described above. It will be apparent that the Z cut through back-up ring 400 formed by first cut 410 and second cut 405 allows back-up ring 400 to be reversed from the position shown in FIG. 20 such that face 404 rather than 402 could engage seal ring 30. In a sense, the embodiment shown in FIG. 20 is a variation of the embodiments shown in FIGS. 13 and 14 and can be considered to have three independent cuts, i.e., cut 406, cut 408 and cut 410. In any event, if cut 405 be considered the second cut, it will be seen that the first cut is at an angle of less than 90° to face 402 while at least a portion of the second cut 405 is at an angle of 90° to second face 404.

The term “interconnected” as used herein does not mean that the first and second cuts, i.e., the cuts from the first face or the second face, respectively, must directly intersect. Rather, as shown in FIGS. 13 and 14, those cuts can be connected by a third cut which is generally parallel to the faces and, preferably, has one end connected to the innermost end of the first cut and the other end connected to the innermost end of the second cut, the connecting cut lying between and generally parallel to faces 110 and 112. It is also to be noted, as discussed above, that the intermediate cut connecting the first and second cuts need not be parallel to the first and second faces so long as the first and second cuts are interconnected as described above.

The term “radial cut” as used herein refers to a cut which is made in one of the faces of the back-up ring whether it be a cut at 90° to the face or at some angle to the face. Thus, the scarf cuts described above are radial cuts albeit that they are not perpendicular to the faces into which they are cut. Thus, radial cut is to be distinguished, in the present application, from cuts such as 104 and 116 which lie wholly between the first and second faces and extend through an outer, annular surface and an inner annular surface of the body of the back-up ring.

Although the first and second cut can be of equal width, generally the first cut, i.e., the cut in the face of the back-up ring that engages the seal ring will have a width less than the width of the second cut, i.e., the cut distal the face which engages the back-up ring. Additionally, preferably the second cut will have a width which allows circumferential expansion of the back-up ring and closing of the gap created by the cut while preventing overlapping of the surfaces making up the lap joint created by the first cut. Generally speaking, the first and second cuts will interconnect at a point approximately midway between the first and second faces. However, the point of intersection, whether it be direct contact between the first and second cut or via an intermediate cut as shown in FIGS. 13 and 14 will be preferably greater than 20 and less than 60 percent of the axial thickness of the back-up ring as measured from the first face to the second face. The first and second cuts need not necessarily intersect or interconnect at their respective innermost ends in the body of the back-up ring. Thus, either or both of the first and second cuts could extend a degree beyond this point of intersection. This is also time when there is a third cut as shown in FIGS. 13 and 14. Indeed, in these cases all these cuts could extend beyond their respective intersection points. As noted, while the first and second cuts can be of equal width, in the preferred case, the second cut has a width greater than the first cut width, especially in cases where the seal is subjected to high temperatures and there is significant thermal expansion of the back-up ring. As noted above, the width of the first cut and the second cut can be substantially the same but preferably the width of the second cut is greater than the width of the first cut. While the exact width of the cuts will vary depending upon the material from which the back-up ring is constructed, its intended usage, i.e., temperature/pressure conditions and other factors, generally speaking the ratio of the width of the first cut to the second cut will range from 1:1 to 1:6.

The seal rings used in the sealing assembly of the present invention can be of various types and made from a wide variety of materials typically used in making resilient or elastomeric seals. The seal ring may be injection molded or otherwise formed of a resilient or elastomeric material such as a synthetic or natural rubber, a polymeric material such as a silicone, a fluoropolymer, or a thermoplastic polyurethane such as diphenylmethane diisocyanate (MDI)-based, tolidine diisocyanate (TODI)-based, or, a p-phenylenediisocyanate (PPDI)-based polyurethane, PTFE and its alloys, etc. As used herein, the term “elastomeric” is ascribed its conventional meaning of exhibiting rubber-like properties of compliancy, resiliency or compression deflection, low compression set, flexibility, and an ability to recover after deformation, i.e., stress relaxation. In general, the seal ring may be made of any material which has sufficient resiliency that it can be forced under pressure into sealing engagement with another member.

In cases where the seal ring is of the lip type, it is common for the seal ring to have a body portion and a lip(s) portion which are generally resilient and a harder, anti-extrusion section. The body portion and the lip portion can be made from materials as described above with respect to the seal rings. The anti-extrusion section(s) of such lip type seals can be made from a variety of materials such as disclosed, for example, in U.S. Pat. No. 4,219,204, incorporated herein by reference for all purposes.

Thus, the term “seal ring” is intended to include any structure regardless of its shape which is sufficiently elastomeric or flexible to effect a seal between radially disposed inner and outer members, be they stationary, rotating or reciprocating.

The back-up rings of the present invention, as compared to the seal rings, are harder, have lower elongation and higher modulus than the seal rings and are generally non-extrudable under either high temperature and/or high pressures albeit because of the split nature, portions of the back-up ring on either side of the split can experience relative, circumferential movement as disclosed with respect to the prior art assemblies discussed above, i.e., the back-up rings can experience thermally induced expansion. As also noted, the back-up rings, once subjected to high temperatures are subject to thermal expansion with concomitant circumferential expansion and, as described above, closing of the gap extending from the face distal the face of the back-up ring engaged by the seal ring.

A wide variety of materials can be used to make the back-up rings of the present invention. Generally speaking, the back-up rings can be made of thermosetting materials or certain thermoplastic material which can incorporate various fillers, fibers, or other reinforcements, including metallic materials, all of which are designed to retain the structural integrity of the back-up ring to the extent possible. Typically the back-up rings are comprised of a thermosetting material alone, e.g., phenol-formaldehyde resins, PTFE, urea-formaldehyde resins, or in admixture with polyester resins, epoxy resins, etc., or in admixture with reinforcing agents such as fiberglass, graphite fibers, carbon fibers, high temperature resistant fibers of polymers, metallic fibers or mesh, etc. Thermoplastic materials such as nylon polyamides, PEEK, PEKK, etc. can also be used. While as noted the back-up rings can include metallic reinforcement, e.g., metallic mesh, fibers, etc, the back-up rings of the present invention are generally not of an all-metallic structure unless the metal is sufficiently ductile to allow it to be manipulated sufficiently to be positioned in closed gland assemblies or on the inner member as described above.

The foregoing description and examples illustrate selected embodiments of the present invention. In light thereof, variations and modifications will be suggested to one skilled in the art, all of which are in the spirit and purview of this invention.

What is claimed is:

1. An annular back-up ring for use in a sealing assembly comprising:
an annular body, said annular body having a first face and a second face, and defining an axial thickness therebetween, said first face being adapted to be engaged by an annular seal ring, a first cut in said first face, said first cut extending axially inwardly from said first face at an angle of less than 90° but greater than 0° to said first face, to a point between said first and second faces, a second cut in said second face, said second cut being interconnected to said first cut and having a portion at an angle thereto, the angle of said portion of said second cut being 90° or greater but less than 180° to said second face.

2. The back-up ring of claim 1, wherein said first and second cuts directly intersect.

3. The back-up ring of claim 1, wherein said first and second cuts are interconnected by a third cut, said third cut lying wholly within said body between said first and second face, said body having an outer, annular surface and an inner, annular surface, said third cut extending through said inner and outer, annular surfaces.

4. The back-up ring of claim 3, wherein said third cut is generally parallel to said first and second faces.

5. The back-up ring of claim 2, wherein said first cut and second cut are interconnected at their innermost ends between said first and second faces.

6. The back-up ring of claim 1, wherein said first cut is at an angle of from 20 to 70° to said first face.

7. The back-up ring of claim 6, wherein said second cut is at an angle of 90° to said second face.

8. The back-up ring of claim 4, wherein said first cut is at an angle of 25 to 350 to said first face and said second cut is at an angle of 12° to 145° to said second face.

9. The back-up ring of claim 4, wherein said second cut is at an angle of 90° to said second face.

10. The back-up ring of claim 4, wherein said second cut is at an angle of greater than 90° to said second face.

11. The back-up ring of claim 10, wherein said second cut is at an angle of from 90° to 160° to said second face.

12. A sealing assembly for sealing between radially inner and radially outer members comprising:
a back-up ring, said back-up ring comprising:
an annular body, said annular body having a first face and a second face, and defining an axial thickness therebetween, said first face being adapted to be engaged by an annular seal ring, a first cut in said first face, said first cut extending axially inwardly from said first face at an angle of less than 90° but greater than 00 to said first face, as determined by an axis perpendicular to said first face, to a point between said first and second faces, a second cut in said second face, said second cut being interconnected to said first cut and being at an angle thereto, the angle of said second cut being 90° or greater but less than 180° to said second face, as determined by an axis perpendicular to said second face; and
a seal ring, said seal ring engaging said first face of said back-up ring.

13. The sealing assembly of claim 12, wherein said seal ring comprises an O-ring.

14. The sealing assembly of claim 12, wherein said seal ring comprises an annular lip seal.

15. The sealing assembly of claim 14, wherein said annular lip seal is a radially outer lip seal.

16. The sealing assembly of claim 12, wherein said seal ring comprises a cup seal having radially inner and radially outer lip seals.

17. The sealing assembly of claim 12, wherein said first and second cuts directly intersect.

18. The sealing assembly of claim 12, wherein said first and second cuts are interconnected by a third cut, said third cut lying wholly within said body between said first and second face, said body having an outer, annular surface and an inner, annular surface, said third cut extending through said inner and outer, annular surfaces.

19. The sealing assembly of claim 18, wherein said third cut is generally parallel to said first and second faces.

20. The sealing assembly of claim 17, wherein said first cut and second cut are interconnected at their innermost ends between said first and second faces.

21. The sealing assembly of claim 12, wherein said first cut is at an angle of from 20 to 70° to said first face.

22. The sealing assembly of claim 19, wherein said first cut is at an angle of 25 to 350 to said first face and said second cut is at an angle of 12° to 145° to said second face.

23. The sealing assembly of claim 19, wherein said second cut is at an angle of 90° to said second face.

24. The sealing assembly of claim 19, wherein said second cut is at an angle of greater than 90° to said second face.

25. The sealing assembly of claim 12, wherein said second cut is at an angle of from 90° to 160° to said second face.

26. The sealing assembly of claim 13, wherein said first face has an annular concave recess for receipt of said O-ring.

27. The back-up ring of claims 1 or 12, wherein at least one of said first or second cuts is curved.

28. The back-up ring of claims 1 or 12, wherein both of said first and second cuts are curved.

29. The back-up rings of claim 1 or 12, wherein said second cut has a first portion and a second portion, the angle of said second portion being 90° or greater but less than 180° to said second face.

30. The back-up ring of claim 29, wherein said second portion lies wholly between said first and second faces.
